(19) United States
(12) Patent Application Publication
(10) Pub. No.: US 2012/0119573 A1
(43) Pub. Date: May 17, 2012

(54) Ultra High Efficiency Transmission, with Grid Tied Energy Storage Capability, for a Wind Turbine or a Fuel Cell or Battery Powered Electric Vehicle

(76) Inventor: Andy Turudic, Hillsboro, OR (US)

(21) Appl. No.: 12/948,639

(22) Filed: Nov. 17, 2010

(51) Int. Cl. B60L 1/00; H02J 1/10; H02P 27/00

(52) U.S. Cl. 307/10.1; 318/400.3; 307/71

(57) ABSTRACT

A transmission for a motor vehicle is provided. The transmission is a plurality of switches that reeonfigurably interconnects constrained energy sources through switch settings. In one embodiment, the energy sources are batteries or fuel cells for an electric or hybrid motor vehicle. The transmission is in communication with a controller that receives energy from the plurality of energy sources and regulates output energy. In one embodiment the controller is a pulse width modulation controller and may also be an inverter and/or converter. A device for converting the output energy of the controller into one of a force or a rate is provided. In one embodiment the device is an electric motor.

### BACKGROUND

A typical transmission, also commonly known as a gearbox, provides speed and torque conversions from a rotating power source to another device using gear, pulley, sheave, or cone ratios. Transmissions can be found in many forms of industrial, commercial, and consumer devices, though one of the most common applications for transmissions is in motor vehicles, where the transmission adapts the variable output of the engine to the drive wheels. The engine operates at a relatively high rotational speed, which is inappropriate for starting, stopping and slower travel. Thus, one function of the transmission is to reduce the higher engine speed to the slower wheel speed and increasing torque in the process. Transmissions may also be used on pedal bicycles, fixed machines, anywhere else where speed and torque needs to be adapted, where input, or output, torque/speed or energy is variable where respective output, or input, torque/speed is to be held relatively constant or within a limited narrow or wider range, and where some form of energy is converted into a product of force and distance per unit of time, or voltage and current, also known as power, which typically results in the desired motion or output voltage or current. Transmissions may be used on such devices as wind turbines, where low speed, higher torque, blade forces need to be converted to the high speeds required by an alternator or generator.

Contemporary transmissions are based on mechanical principles. These transmissions contain gears, pulleys, sheaves, cones, or some other fowl of mechanical device typically contained in a cast iron or aluminum case. Due to the mechanical nature of conventional transmissions, the transmissions are prone to wear and inefficiencies. Even in hybrid motor vehicles and electric vehicles conventional mechanical transmissions are utilized to provide torque multiplication due to limitations imposed by limited current availability from fuel cells or batteries due to high internal resistances. The mechanical nature of the currently available transmissions place a ceiling on the efficiency capabilities of the hybrid and/or electric vehicles in extracting the maximum amount of power from an energy source.

It is in this context that the embodiments arise.

### SUMMARY

The embodiments described below provide an efficient transmission for an electric/hybrid vehicle and a technique for capturing the stored energy in electric/hybrid vehicles for use back into a public power grid. It should be appreciated that the present invention can be implemented in numerous ways, including as a method or a system. Several inventive embodiments of the present invention are described below.

In one aspect of the invention, an apparatus is provided. The apparatus includes a plurality of reconfigurably interconnected energy sources. In one embodiment, the energy sources are fuel cells or batteries for an electric or hybrid motor vehicle. The apparatus also includes a controller that receives energy from the plurality of energy sources and regulates output power. In one embodiment the controller is a pulse width modulation controller and may also be an inverter and/or converter. The apparatus includes a device for converting the output energy of the controller into one of a force or a rate. In one embodiment the device is an electric motor. The embodiments may be integrated with a vehicle having a combustion engine.

In another aspect of the invention, the excess stored energy from the batteries of a vehicle is made available to the power grid. Logic contained either on the vehicle or at a charge pedestal enables an owner of the vehicle to specify an amount of battery capacity necessary for a trip to the next charge station. Thus, when the owner is working, shopping, or performing some other non-driving activity and the vehicle is parked near a charge pedestal, the excess capacity of the energy stored by the vehicle can be delivered back to a power grid.

Other aspects and advantages of the invention will become more apparent from the following detailed description, taken in conjunction with the accompanying drawings, illustrating by way of example the present invention.

### BRIEF DESCRIPTION OF THE DRAWINGS

The invention, together with further advantages thereof, may best be understood by reference to the following description taken in conjunction with the accompanying drawings.

FIG. 1 is a simplified schematic electrically modeling a cell as an ideal voltage source (Vc) with a series resistor.

FIG. 2 is a simplified schematic diagram illustrating the components of a vehicle having an electronic transmission in accordance with one embodiment of the invention.

FIG. 3 is a simplified schematic diagram illustrating a battery pack of reconfigurable, dynamically alterable connections of modules that are capable of the torque conversion functionality of a transmission without the mechanical or moving parts of a conventional transmission in accordance with one embodiment of the invention.

FIGS. 4A through 4D illustrate various embodiments and the corresponding components for tying into a public grid to charge the vehicle, as well as providing power back to the public grid in accordance with one embodiment of the invention.

FIG. 4E is a simplified schematic diagram providing further details on the embodiment of FIG. 4D where the motor is integrated into the hub of a wheel in accordance with one embodiment of the invention.

FIGS. 5A-C are simplified schematic diagrams illustrating hardware for achieving a technique for utilizing vehicles as energy storage devices that can supply and track the time and supplied power into a grid in accordance with one embodiment of the invention.

FIGS. 6A-6E illustrate a switch configuration with common busses functioning as a transmission for energy sources to achieve certain gear ratios in accordance with one embodiment of the invention.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

The embodiments relate to a drivetrain for an electric vehicle that includes at least one electric motor as a converter of electrical energy into motion, generally, but not necessarily, rotary, whereby the motor is presented to the input of a mechanism that is capable of producing quantized steps of torque and speed in inverse relation to each other in the vehicle drivetrain. This is conventionally known as a “transmission” and the quantized steps are known as “gears” or “speeds”. It is common practice to equip vehicles with transmissions having two, three, four, five, and six speeds, with heavy vehicles being equipped with up to eighteen or more speeds. The gears of the transmission may be changed either manually or by a control system. The gears or speeds in a conventional mechanical transmission are counted in sequence from a designation of “first” for the gear that multiplies the input torque of the transmission by its maximum value, and then an increasing integer numerical sequence of designators that represents the torque value produced until the least torque multiplication is achieved in the highest gear. Typically, the highest gear has a reduced torque from the input and is known as “overdrive.” As an example, in a “6-speed” transmission attached to an electric motor, first gear produces the greatest torque multiplication and lowest top speed, with sixth gear producing the highest speed and lowest torque multiplication. For example, in the TESLA ROADSTER electric car, the electric motor was the input to a two speed transmission, allowing the car to claim unprecedented acceleration due to the torque multiplication offered by first gear, yet achieved good range and speed with its second gear. Unfortunately, this two speed mechanical transmission was reported to have had major failures and was discontinued in favor of the compromising aspect of not being able to alter the speed/torque output of the drivetrain due to limitations set by the energy source, i.e., the battery pack. Many electric vehicles have used conventional quantized or continuously variable mechanical transmissions that permit variable torque/speed at the wheels, or use a singular torque ratio between the motor and the drive wheels exemplified in the TESLA ROADSTER, in realizing an electric vehicle drivetrain. Some, in the interest of efficiency, have resorted to CVT (Continuously Variable Transmissions) in order to increase drivetrain efficiency, with better efficiencies appearing to be on the order of 80% to 85%.

The electric motor usually converts electrical energy into a magnetic field, which then imparts linear or, more generally rotary, force on a shaft. In the case of a DC rotary machine, the torque, or twisting force on the shaft is proportional to the current being delivered to the motor. In vehicles with a “single speed” transmission, variable torque is achieved by varying current, generally by PWM (Pulse Width Modulation) methods, being delivered to a DC motor. The highest speed of the motor shaft is proportional to the applied voltage to the motor. In an electric vehicle, drivetrain torque produces force that results in acceleration, whereas drivetrain speed produces vehicle speed. One skilled in the art will appreciate that the speed of the vehicle and the torque are determined by the output torque and speed of the motor, multiplied by the factors in the transmission. A final fixed speed or torque factor conversion may result in a “differential.” The combination of motor, transmission, and differential is known as the drivetrain.

In addition to the drivetrain, an electric vehicle must have an electrical energy source (EES), which can include a DC generator or AC alternator (hereafter referred to as “generator” for either one), a fuel cell, a battery system, etc. In other embodiments, alternate energy sources (AES) may be substituted for the EES and could include air or hydraulics, as an example. With air or hydraulics, one skilled in the art will appreciate that the analogy of pressure is voltage and the analogy of flow is current. For the sake of brevity, the embodiments discussed in detail herein focuses on an electrical source of energy, such as a battery, though fuel cells, generator/alternator are interchangeable in this discussion in general and alternative energy sources may be incorporated into the embodiments described herein. Batteries typically have multiple quantized elements known as “cells”. As used herein, “modules” refer to multiple batteries or cells, and packs are multiple modules, batteries or packs.

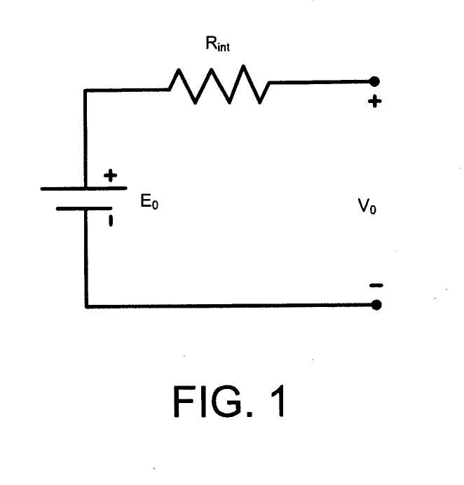

FIG. 1 is a simplified schematic electrically modeling a cell as an ideal voltage source (Vc or Eo) with a series resistor. The series resistor (Rc or Rint) represents the “internal resistance” of the cell. As more current (Ic) is drawn from a cell, it can easily be seen by those versed in the art that the output voltage (Vco or Vo) will “droop” or be reduced by the product of Ic and Rc (Vco=Vc−(Ic*Rc)). As the current draw increases, the droop proportionally increases and the output voltage of the cell decreases. Further, the amount of heat produced in the battery is proportional to the power dissipated in its internal resistance Rc and is proportional to the square of the current draw, with the power in the internal resistor being Pc=Ic*Ic*Rc.

Batteries are formed by connecting multiple cells (N, Np, or Ns), where N represents the number of cells, Np represents the number of cells in parallel, and Ns represents the number of cells in series with series connections producing integer multiples of cell voltages (Ns*Vc volts) and parallel connections resulting in decreased internal resistance (Rc÷Np ohms). For a maximum allowable cell current (Icm), a battery with parallel cells will produce Np*Icm amps of maximum current, whereas series connected cells produce Icm amps of maximum current. The maximum current rating, Icm, is typically determined by the thermal limit, or lifetime predictions, of the cell, which generally produces heat proportional to the power in the internal resistor (Pc).

Cells may include varying material combinations which produce desirable attributes that can include energy density, low internal resistance, maximum current output, lifetime in terms of number of charge cycles or hours, safety, temperature range, leakage, etc. All of these attributes listed are important in an electric vehicle application, though an optimization must be made by a designer since all of these attributes are not available in a given battery design as maxima of desirability, resulting in a compromise of one or more desirable vehicle performance attributes. As already mentioned, cells can also be extended to include fuel cells, or output windings of a generator. Batteries with the highest energy density generally exhibit the highest internal resistance and therefore have a lower current output capability due to thermal limitations. Approaches to mitigate the thermal problem include such solutions as liquid cooled battery packs to allow high current output for short periods of time.

As previously mentioned, DC motor torque is proportional to current, and speed is proportional to voltage. To achieve higher torque capability, vehicle designers for electric and hybrid vehicles must use high current output batteries or modules which ultimately add weight due to lower energy density. This added weight requires even more torque to produce a given amount of torque or acceleration. However, a quickly accelerating golf cart is not acceptable to highway vehicles, and therefore these modules or batteries must be “stacked” in larger quantities in series to produce enough voltage to obtain speed.

The embodiments described herein recognize the inefficiency of mechanical transmissions for torque and speed conversion and enable a vehicle to dispense with them entirely. This in turn substantially reduces weight, eliminates the need for, and disposal of, oil-dependent lubricants, improves driveline efficiency, improves vehicle packaging flexibility, reduces driveline noise and vibration, and significantly improves vehicle reliability as there are no moving parts in the power path between the motor and the wheels. In addition, the embodiments provide for speed and torque conversions without the need for a mechanical transmission in the drivetrain, i.e., placed between the output of the motor and the wheels of the vehicle. That is, in one embodiment, the output of the motor is directly coupled to the wheels, e.g., through a shaft coupling the motor and the wheels or though a motor embedded in a wheel hub. In these embodiments the conventional transmission is eliminated and what is referred to as the transmission in the embodiments described herein is outside the drivetrain or driveline defined between the motor and the wheel.

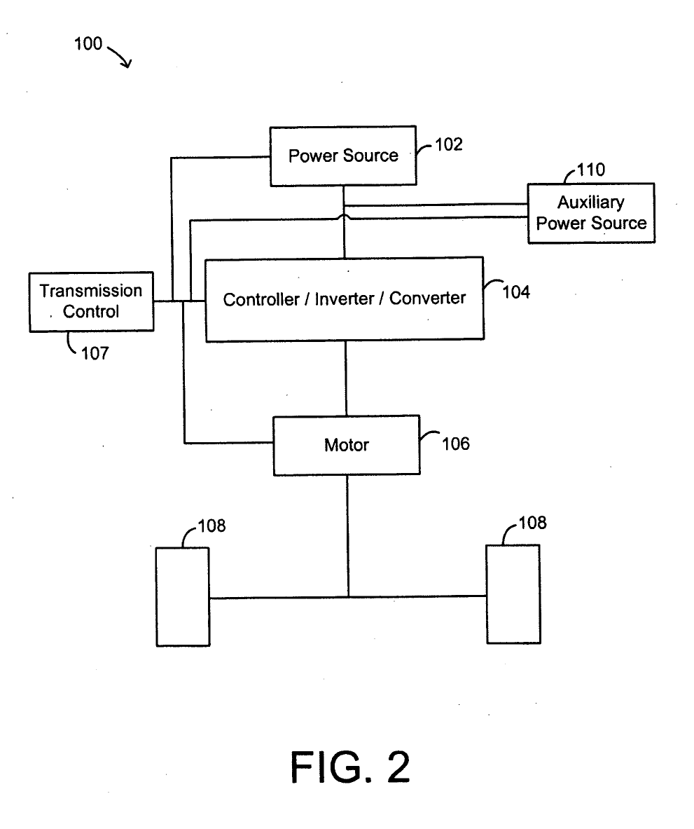

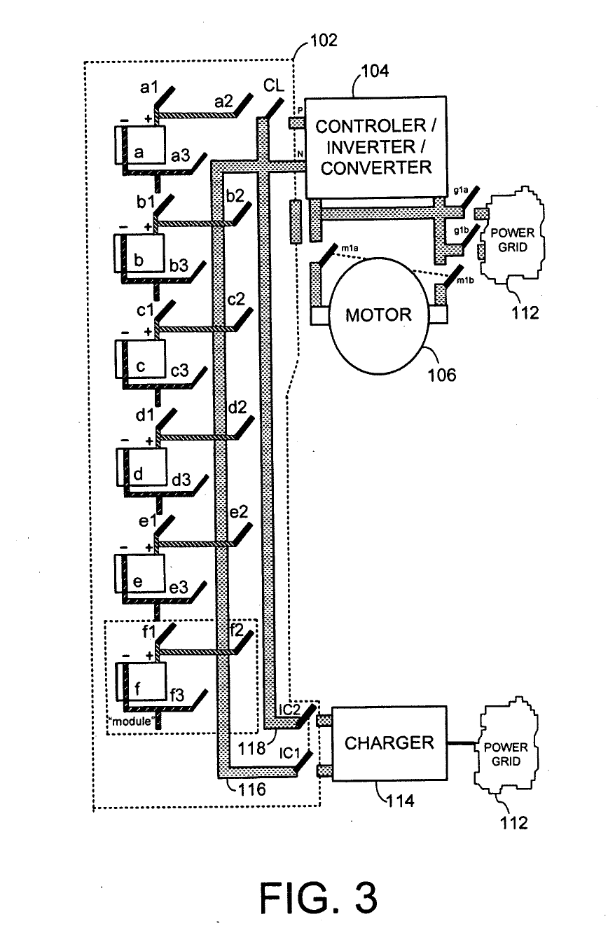

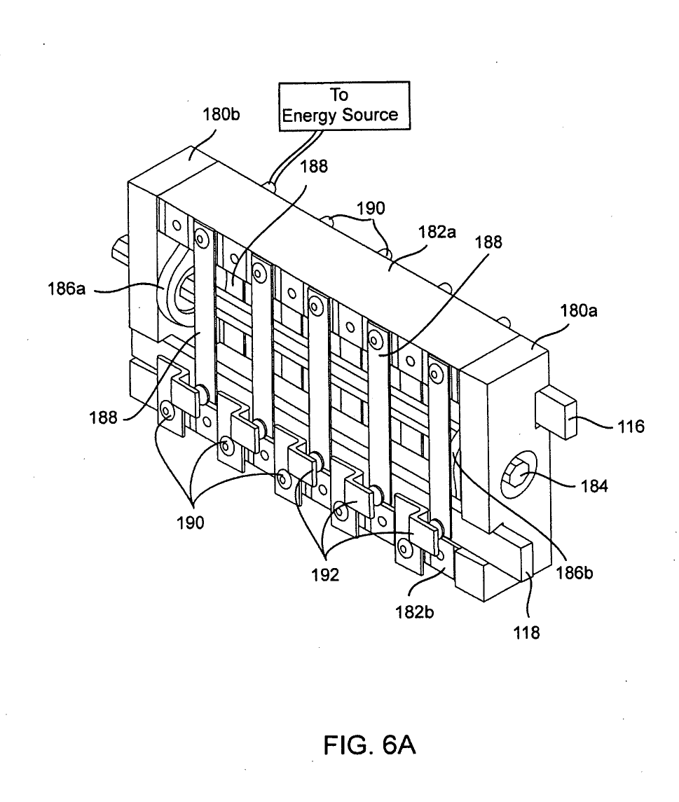

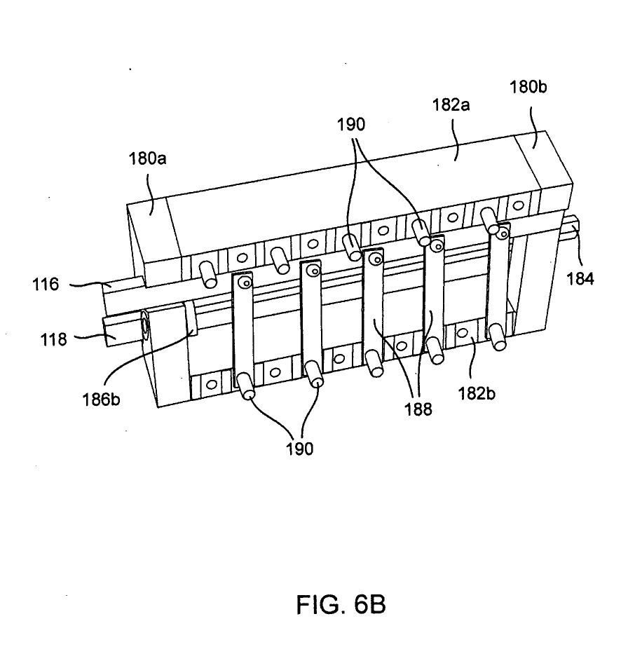

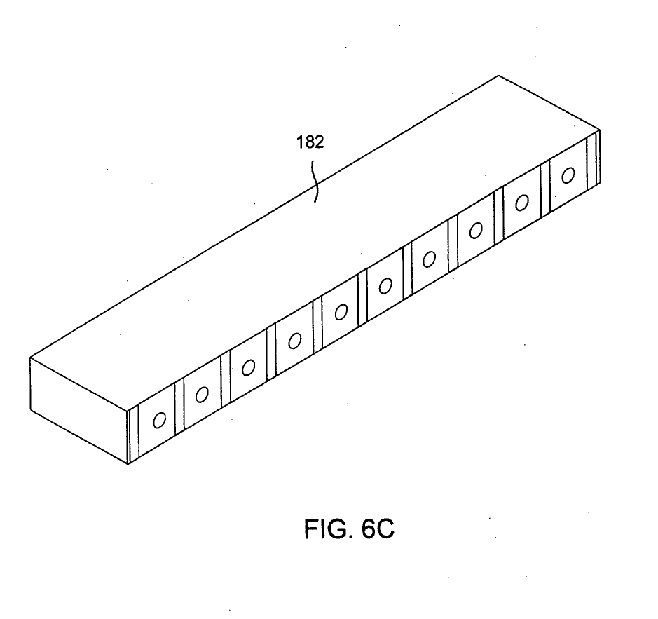

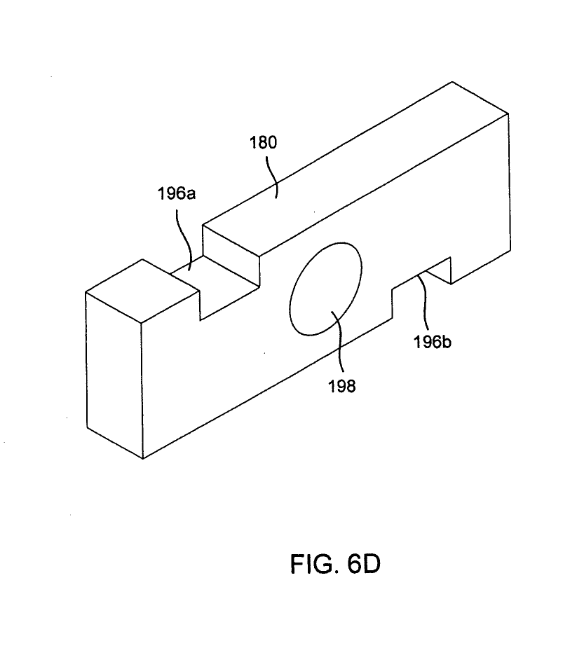

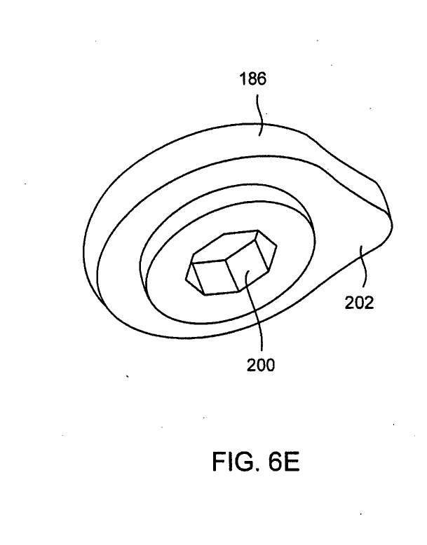

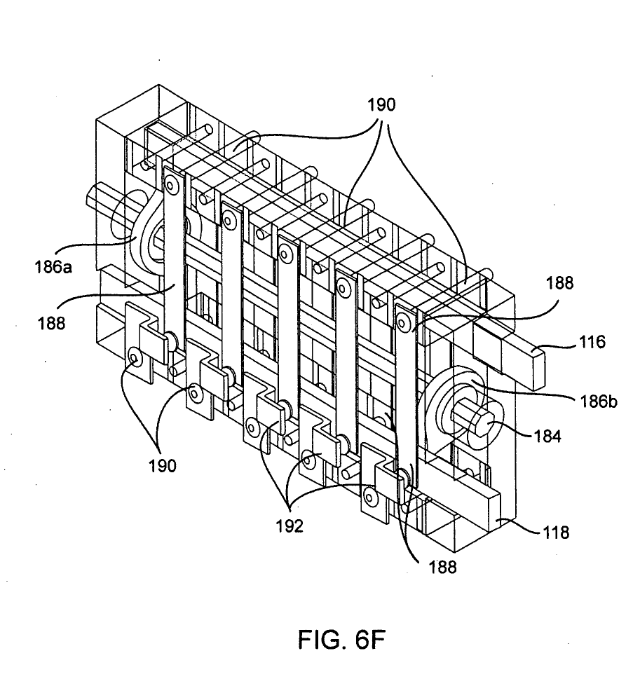

FIG. 2 is a simplified schematic diagram illustrating the components of a vehicle having an electronic transmission in accordance with one embodiment of the invention. Power source 102 is coupled to controller/inverter/converter 104. Controller 104 is coupled to motor 106 which powers wheels 108 of motor vehicle 100. Auxiliary power source 110 is also optionally provided. It should be appreciated that auxiliary power source 110 may provide backup or spare power sources in the event there is a problem with one of the reconfigurable power sources in module 102. In another embodiment, auxiliary power source 110 functions as an additional reservoir for storing power from regenerative braking. Controller 104 functions as a pulse width modulator (PWM) in accordance with an embodiment of the invention that incorporates a DC motor. Controller 104 serves to control the actual torque or speed of motor 106. In one embodiment, motor 106 may be directly coupled to the hub of wheels 108, as described in more detail below. Transmission control 107 functions to interpret signals from sensors, which may or may not be located on the vehicle, and from an operator of vehicle 100 and provide the control signals to switch gears through reconfiguring energy sources, charge the batteries, or provide power back into the grid as explained further below, among other control features. One function of transmission control 107 is to ensure sufficient voltage or current is available from the energy sources to provide, without exceeding the maximum current rating or temperature of each cell for any extended period of time, the requested or anticipated, torque or speed from the vehicle operator or other input and to deliver this maximum capability to controller 104. For example, transmission control 107 may be in communication with controller 104 and with sensors that capture the speed, or torque demand, of the vehicle for purposes of shifting gears, i.e., changing switch positions of the reconfigurable energy sources of power source 102. Transmission control 107 also serves to reconfigure and optimize the energy sources as energy storage for either charging or for regenerative braking. In another embodiment, transmission control 107 functions as a power supply or reservoir for external devices or networks/grids. It should be appreciated that the term shifting gears refers to altering the parallel or series configuration of energy sources as the embodiments described herein do not employ the mechanical gears of a conventional transmission, as illustrated below with reference to FIG. 3. In one sense, the transmission provided herein achieves the torque conversion through a plurality of immobile or non-moving components, e.g., solid state switches. Other embodiments may utilize mobile components, such as an electromechanical switch or the switch of FIGS. 6A-E, where rotation of a shaft causes reconfiguration of the energy sources.

Still referring to FIG. 2, it should be appreciated that the embodiments described herein enable the elimination of a mechanical transmission in the driveline or drivetrain between motor 106 and wheels 108. As described further below, a plurality of reconfigurable power sources within power source 102, in combination with controller 104 and transmission control 107, are dynamically configured to provide the necessary torque, i.e., the necessary current, and the necessary speed, i.e., the voltage, as described below. The embodiment of FIG. 2 may be combined with an internal combustion engine (ICE) to provide a hybrid power configuration for vehicle 100. In one embodiment, the vehicle may include a reconfigurable generator that utilizes the invention for the ICE, while the electric motor and the accompanying drivetrain include the configurable energy sources described herein.

FIG. 3 is a simplified schematic diagram illustrating a battery pack of reconfigurable, dynamically alterable connections of modules that are capable of the torque conversion functionality of a transmission without the mechanical or moving parts of a conventional transmission in accordance with one embodiment of the invention. The example in FIG. 3 is a “four speed transmission” where each energy source of a set of six identical energy sources a, b, e, d, e, f, is provided with the ability to connect to the next module in series via corresponding switches a1-f1. Power source 102 includes energy sources a-f, which may be coupled independently with corresponding switches a2-f2 to a common bus for positive polarity and with corresponding switches a3-f3 to a second common bus for negative polarity, i.e., these switches (a2-t2 and a3-f3) enable the arrangement of power sources a-f in parallel. It should be noted that these switches (a1-f1, a2-f2, a3-f3, as well as g1a, g1b,m1a,m1b, IC1, IC2, and CL) may be of any form, including electromechanical devices or various types of solid state devices, not limited to metal oxide semiconductor field effect transistors (MOSFETs), insulated gate bipolar transistors (IGBTs), bipolar junction transistors (BFI's) in silicon, silicon carbide, gallium nitride, or other non-solid state suitable switching device. It should be appreciated that the transmission of FIG. 3 only has losses due to the “contact” resistance of the switches, resulting in a gear-changeable transmission with an efficiency that approaches 100%, as contrasted with the 80-85% efficiency of best conventional transmissions. Thus, the switches described herein enable energy sources a-f to be dynamically reconfigured as desired to provide currents in excess of the maximum for a single cell, yet also be configured to provide higher voltages required to produce motor speed. In one embodiment, the configuration of the interconnected power sources a-f is altered in response to a control signal triggered by a suitable controller monitoring some operating parameter of the vehicle, similar to control for an automatic transmission.

With each module capable of a maximum current of 1 mm and maximum voltage of Vmm, quantized “gear ratios” can be attained with strategic closure of switches a1-f1, a2-f2, and a3-f3, without compromising battery life or maximum internal battery temperatures. A four speed transmission embodiment using switches a1-f1, a2-f2, and a3-f3, with switch settings shown below results in the effective ratios and corresponding amperage (amps) and voltage output illustrated in Table 1. Of course, any number of power sources may be utilized and the 4 speed transmission is just one example of the number of arrangements of the power sources.

TABLE 1

| | | IMAX (TORQUE) | VMAX (SPEED) |
|---|---|---|---|
| GEAR | EFF RATIO | (Amps) | (volts) |
| 1 | 1:6 | 6 A | 1 V |
| 2 | 1:3 | 3 A | 2 V |
| 3 | 1:2 | 2 A | 3 V |
| 4 | 1:1 | 1 A | 6 V |
| Neutral | 0 | 0 | 0 |

The switch positions for obtaining the effective ratios and torque and speed are provided below.

First gear is achieved by closing, i.e., making contact through the switch, the following switches: Gear 1: a2 b2 c2 d2 e2 f2 a3 b3 c3 d3 e3 f3 CL m1a m1b.

Second gear is achieved by closing the following switches:
Gear 2 a2 b1 c1 c3 d2 e1 f1 f3 CL m1a m1b.

Third gear is achieved by closing the following switches:
Gear 3 a2b 1b 3 c2 d1 d3 e2 f1 f3 CL m1a m1b.

Fourth gear is achieved by closing the following switches:
Gear 4 a2 b1 c1 d1 e1 f1 f3 CL m1a m1b.

Neutral is achieved by opening the clutch switch (CL), thereby disconnecting the energy sources a-f from the positive terminal of controller 104.

It should be appreciated that reverse is achieved by reversing the polarity of the voltage provided to the DC motor and, for safety, the number of gears in reverse may be restricted by transmission controller 107 or reduced by controller 102. Accordingly, the gear ratios are achieved by arranging the plurality of energy sources in parallel, series, or a parallel/series combination.

Still referring to FIG. 3, first gear places all six energy sources a-f in parallel to form an energy source pack, resulting in a maximum current of 6*Imm without “cooking” or overheating the cells of the energy sources. It should be appreciated that energy sources a-f may be referred to as individual energy sources or as part of a module that includes the energy source and the corresponding switches. For example, module f includes energy source f and switches f1, f2, and f3 that are coupled to energy source f, as illustrated in FIG. 3. Furthermore, when all six modules a-f are in parallel, a voltage of Vmm and a motor torque of approximately six times nominal and a nominal speed is achieved since torque is proportional to current and speed is proportional to voltage. In a conventional direct drive implementation, the 6*Imm current would need to be supplied from one module, and for the same module resistance (Rm), thirty six times the power is dissipated (power is square of current), as compared to the rate maximum current, in the internal resistance of the module, killing the battery or its lifetime, and possibly causing a fire. Second gear places three modules, in parallel as a “set,” i.e., with two sets (a set being modules a-c and another set being modules d-f in this example) being placed in series to create a pack, yielding a three times nominal motor torque and a two times nominal motor speed. Third gear places two modules in parallel as a “set”, with three sets being placed in series, to form a pack yielding two times the nominal motor torque and three times the nominal motor speed. Finally, fourth fear places all modules in series to form a pack, yielding nominal motor torque and six times the nominal motor speed.

Another aspect of maximizing energy efficiency of vehicles is by exploiting “regeneration”, or “regen”, which recognizes that when an electric motor exceeds the speed of that determined by its applied voltage, the motor acts as a generator that converts kinetic energy into electrical energy, i.e., the motor acts like a brake, and the electrical energy can be stored in a battery pack. Since conventional battery packs are hard wired, regen requires additionally complex and inefficient controllers to ensure that the back electromagnetic field (EMF) somehow ends up in the battery pack, usually with a step-up DC/DC power converter since back EMF is produced when the speed of the motor is greater than the speed the motor would have produced had that battery voltage been applied and conventional EV batteries are hardwired to produce enough voltage for achieving maximum motor speed requirements, typically 380 Volts direct current (DC). In the embodiment of the four speed setting, each “downshift' lowers the pack voltage below the voltage-determined motor speed, causing the motor to generate electricity and charge the pack through a charge controller until Vm is achieved. From there, it is possible to use conventional regen methods, though the amount of” kinetic energy at low speeds may not be worth the cost or energy gain [E=0.5*(mass of vehicle)*(vehicle speed)*(vehicle speed)]. In another embodiment, certain battery technologies cannot be overcharged, so the braking energy is dumped into a resistive element, which is wasteful. As an alternative or an auxiliary power source 110 of FIG. 2 may incorporate fast charge friendly technologies, including, but not limited to Ni—Cad batteries or super capacitors. Upon further discharge of energy source 102, the energy in auxiliary power source 110 may be used to “top up” by charging energy sources 102 or to provide additional current for acceleration with a different embodiment of connections from those shown herein.

Returning to FIG. 3, by merely changing switches to reconfigure the parallel and series arrangement of the energy modules, the full effect of a mechanical transmission is realized that respects the maximum current limits of the energy source, including braking by downshifting to lower gears. While other ratios, including fractional ratios, are possible by placing some modules, batteries or cells in furlough and bringing others online, this adds to control complexity to “balance” the energy modules, batteries, or cells. One skilled in the art will appreciate that any number of speeds is possible in simplified implementations, as long as integer combinations of modules are connected to where each module is discharged equally for an equal amount of current and for an equal time. Again, a more complex control scheme can keep track of battery use and balance cells, batteries, modules, or packs and is encompassed in this invention as a claim. One skilled in the art will appreciate that the details of the fractional ratios are unnecessary in light of the details provided herein.

Still referring to FIG. 3, a separate charge bus, and the associated switches are not shown, but may be included to allow modules a-f to be charged either offline, or in a combination that favors efficiency or available voltage and/or current. Similarly, a separate cell, battery, or module “balancing” bus is not shown, but included in the embodiments. Again, one skilled in the art will appreciate that the separate cell, battery, or module “balancing” bus allows the equalization of voltages between modules a-f by moving charge from one cell, battery, or module, to another, including auxiliary power sources 110 of FIG. 2 or ICE/generator combinations.

The two common busses 116 and 118 of FIG. 3 can also be configured in a hierarchy as higher level “modules” to form a configurable pack. Busses 116 and 118 are interconnects or traces that may be composed of any suitable conductive material. Switch CL serves as a disconnect from the motor and/or its controller, the analogy being a “clutch” in a conventional drivetrain with a mechanical transmission. The controller is a pulse width modulation (PWM) device for continuous control of speed and direction in one embodiment and functions to deliver any amount of voltage and/or current up to the maximum amount the reconfigurable energy sources can deliver in a particular “gear” or configuration. In another embodiment, switch CL is a high current switch which allows a “break” of the circuit before switching gears. It should be appreciated that switch CL allows lower current DC contacts to be utilized for switches a1-f1, a2-f2, and a3-f3, as there is no need to extinguish a DC arc once switch CL is disconnected and the current has been fully interrupted. In alternative embodiments, switch CL can be mechanically actuated switches, or achieved through the use of cams for sequencing the appropriate switches for each gear, as described in more detail with regard to FIGS. 6A-6E. Switch CL also acts as a system safety switch in one embodiment, where operator, first responders, or sensor input disconnects the energy source from the controllers and motors. In one embodiment, the sensor is a crash sensor (e.g. accelerometer) that stops the motor from producing motion after a severe impact. One skilled in the art will appreciate that a host of safety features may be integrated with the switches providing the transmission functionality of the embodiments described herein due to the electronic nature of the switches. Switch CL can also act as a contactor and, though shown as a single switch on one of the two common busses, switch CL may be a ganged switch with a switch on each of the two busses in another embodiment. Accordingly, one skilled in the art will appreciate numerous permutations may be provided for the reconfigurable energy sources a-f that are functioning as a transmission in conjunction with controller 104.

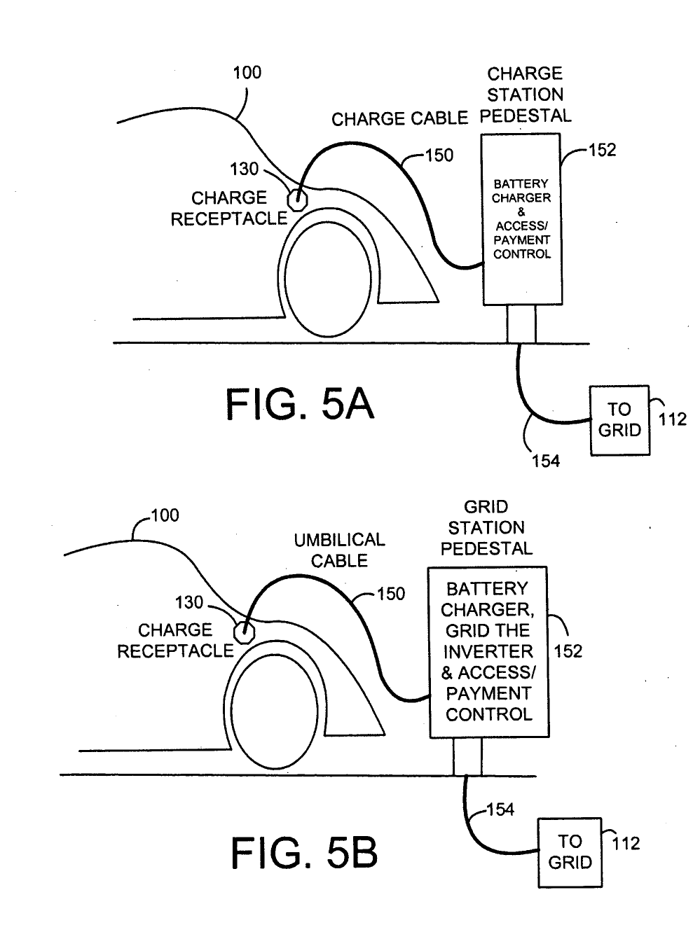

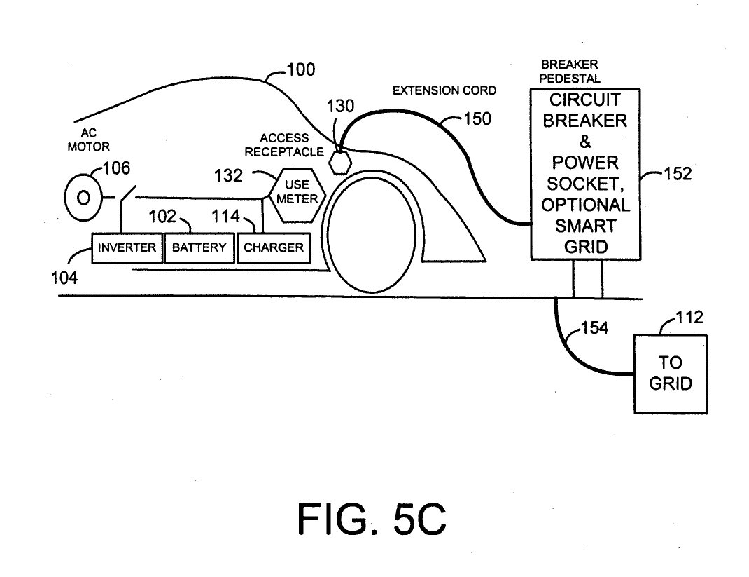

Still referring to FIG. 3, switches m1a and m1b may be utilized to engage and disengage motor 106 from controller 104. For example, through another embodiment of the present invention, the power source for the vehicle may be used to store energy and provide the stored energy to grid 112 for distribution through switches g1a and g1b. That is, in the instance of an owner simply using the vehicle to drive back and forth from work, where the range provided by the battery charge exceeds the amount of range required by the owner, the owner may sell power back into the grid while the vehicle is sitting parked during the workday when peak demand typically occurs, and where alternative energy sources, like wind power, produce minimal generating power. It should be appreciated, that the vehicle is functioning as a store of energy, which can then be provided back to grid 112 through numerous method embodiments described herein. In one embodiment, commands received by the transmission control of FIG. 2 may initiate the dumping of power back to the grid. Accordingly, switches g1a and g1b are closed and switches m1a and m1b are open when providing power back to power grid 112. Further details on this embodiment are provided with regard to FIGS. 5A-5C.

Charger 114 of FIG. 3 is a conversion and control device providing power and control for charging energy sources a-f and may include a timer or communication device to provide charging of the vehicle's energy sources at lowest cost. Charger 114 may be located on the vehicle or on a charging station/pedestal external to the vehicle. In one embodiment, charger 114 may couple the vehicle to power grid 112. As used herein the with power grid may refer to a public power grid that includes transmission lines that distributes electrical power for public consumption. In another embodiment, power grid can be a private grid having limited distribution. In this embodiment, the vehicle is utilized to deliver power from the private grid to the public grid. One skilled in the art will appreciate that when charging the vehicle through charger 114 switches IC1 and 1C2 are closed, while at other times switches IC1 and IC2 are opened.

One skilled in the art will appreciate that energy sources may be batteries in one embodiment but this is not meant to be limiting. Other possible energy sources besides batteries include, fuel cells, wind turbines, solar cells, electrical generators, energy generators, power generators, micro fusion reactors, among other energy sources whether now known or unknown. Each of these energy sources, depending on the application involved, may be substituted as the energy sources for FIG. 3 or any of the other Figures illustrated herein.

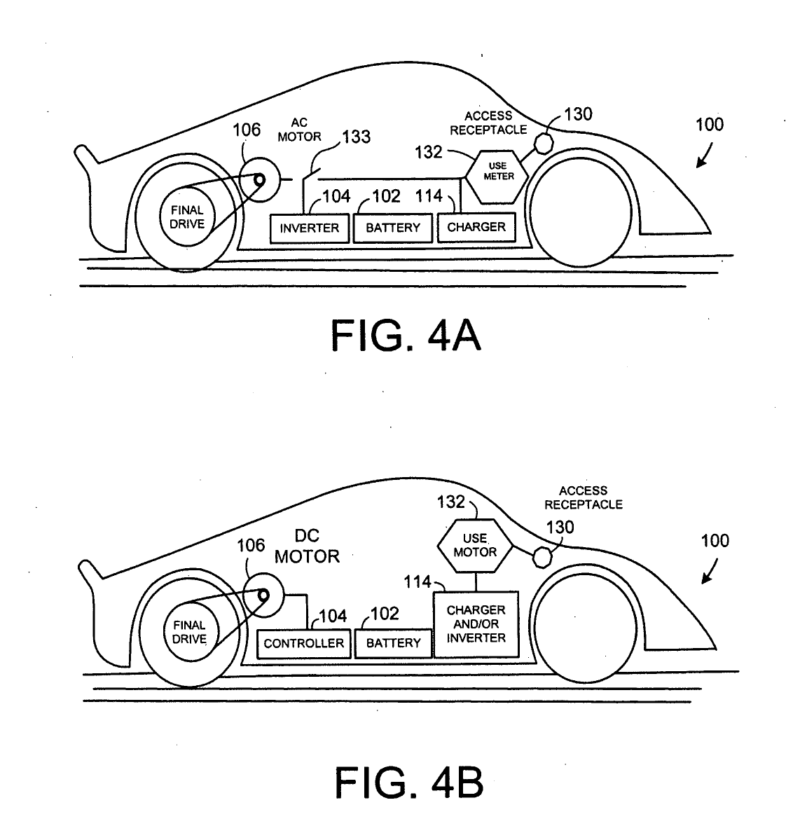

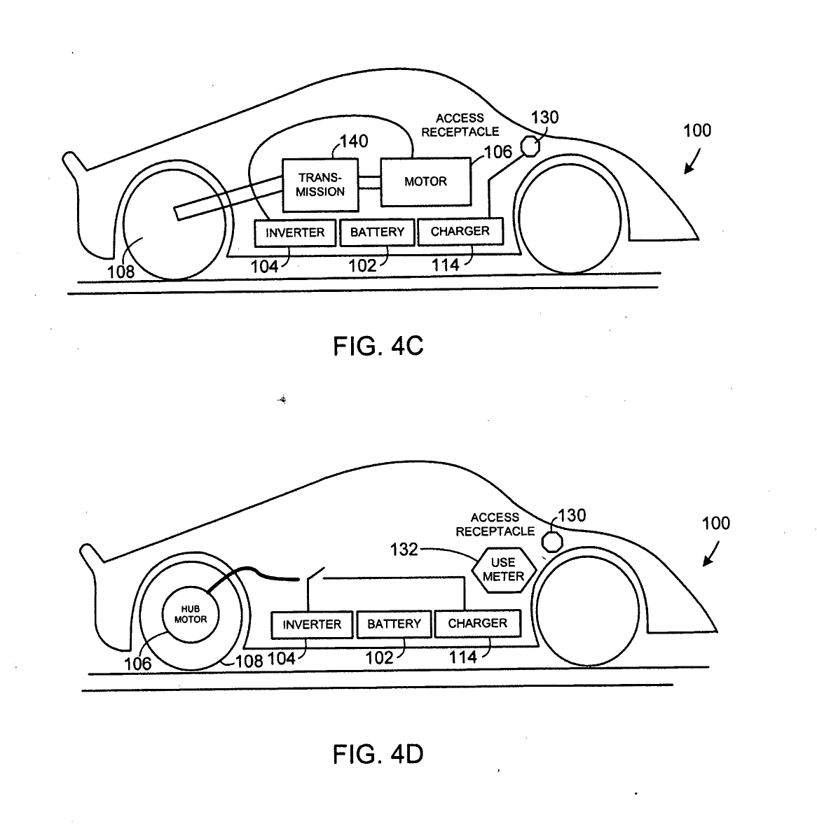

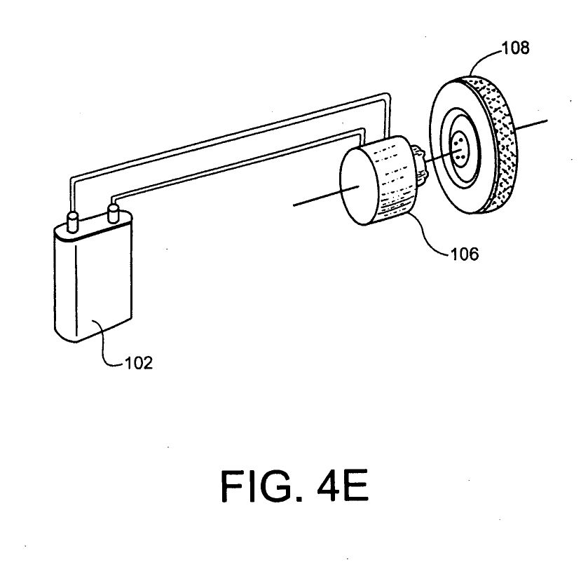

FIGS. 4A through 4D illustrate various embodiments and the corresponding components for tying into a grid to charge the vehicle, as well as providing power back to a grid in accordance with one embodiment of the invention. Vehicle 100 in FIG. 4A includes an access receptacle coupled to use meter 132. Use meter 132 is coupled to charger 114 and inverter 104 through switch 133. Charger 114 is coupled to battery 102, which is coupled to inverter 104. Based on the position of switch 133 inverter 104 can provide energy to drive electric motor 106 or provides grid-synchronized energy back to receptacle 130 which may be transmitted back to a power grid. In FIG. 4B, controller 104 provides a direct current (DC) to motor 106. FIG. 4C illustrates a conventional vehicle having transmission 140 in the driveline and coupled between motor 106 and wheel 108. The embodiment of FIG. 4C is provided to illustrate that vehicle 100 having a conventional transmission 140 in the drive train may be incorporated to provide power back to a power grid and be utilized as a store of energy. While the embodiment of FIG. 4C does not include the electronic transmission described herein, it should be appreciated that any suitable electric or hybrid vehicle may be integrated into the system described herein where vehicle 100 is utilized as a store of energy. FIG. 4D is a simplified schematic diagram illustrating a configuration where the motor 106 is incorporated into the hub of wheel 108. FIG. 4E provides an alternative view of motor 106 integrated into a hub of wheel 108 in accordance with one embodiment of the invention. FIG. 5A-C are simplified schematic diagrams illustrating example embodiments of the hardware for achieving a technique for utilizing vehicles as energy storage devices that can supply and track the supplied power into a grid in accordance with one embodiment of the invention. In FIG. 5A, vehicle 100 is connected to charge station pedestal 152 through cable 150. Cable 150 connects to vehicle 100 through charge receptacle 130. In one embodiment charge station pedestal 152 may be present in any parking lot or at any parking space for vehicle 100. Charge station pedestal 152 is connected to the power grid 112 through cable 154, Charge station pedestal 152 contains access and payment control logic in addition to charging capabilities. In one embodiment the access and payment control logic enables an owner of vehicle 100 to supply and get credit for power delivered back into grid 112, as well as charge the owner if power is derived from the grid for charging the on-board batteries. Thus, as described above, if an owner has excess charge contained in the on-board batteries for planned use prior to the next charge at low energy valuation periods, then that stored energy can be monetized at peak valuation periods and delivered back into grid 112 as a method beneficial to power grid operators/owners and the vehicle owners. In one embodiment, the access and payment control logic of charge station pedestal 152 provides for the tracking of the amount of power taken from or delivered back into grid 112. In another embodiment, FIG. 5A illustrates a technique where charging of the batteries for vehicle 100 is provided, while FIG. 5B illustrates the capability of both charging from grid 112 and delivering power back into the grid. In both the embodiments of FIGS. 5A and 5B the access and payment control logic resides on grid station pedestal 152.

In FIG. 5C inverter 104 functions as a grid-tie inverter, thereby allowing energy storage for the grid by vehicle 100. Batteries 102 may be charged during off-peak hours through charger 114 and a connection to an energy source. During peak hours, or any other time where the vehicle has excess stored energy, which may be purchased at higher cost and replaced at a lower cost as a method, the vehicle may be grid-tied through a connection to pedestal 152. In one embodiment pedestal 152 of FIG. 5C functions as a circuit breaker and power socket with the optional capability of tying into a smart grid. Use meter 132 tracks the electric billing credit when providing power back into the power grid 112 of FIG. 5C. It should be appreciated that an onboard computing device of vehicle 100 can reserve battery capacity for an amount sufficient for a trip to the next charge station or until a lower cost energy period is anticipated in one embodiment. Thus, if an owner of the vehicle realizes the battery level is at full capacity, yet only 20% capacity is needed for a trip back home from work, the owner can program an onboard computing device with the future trip information to calculate the required reserve and provide the access of up to 80% capacity back into grid 112. It should be apparent to one skilled in the art that this method can occur while the vehicle is parked during work hours or any other idle time where supplying the grid is, or is anticipated to be, of higher valued than storing the energy in the vehicle, providing the needed economic rationale for electric vehicles and their eventual battery replacement as a further method embodiments.

One skilled in the art will appreciate that while a vehicle is illustrated in FIGS. 4A-5C, the embodiments may be extended to solar cells, turbines such as wind turbines and jet engine turbines, hydroelectric generators, etc. In essence any suitable energy or power generator/source can be utilized so that the energy/power sources are selectably arranged to optimally and efficiently deliver the desired power level, e.g., voltage or current, to a power grid. In addition, while a motor vehicle is illustrated in the diagrams, this is not meant to be limiting as the embodiments may be extended to any mode of transportation, such as bikes, motorcycles, aircraft, ships, motorboats, submarines, etc. Moreover, the embodiments may also be extended to micro-electro-mechanical systems (MEMS). For example, static friction or stiction issues can be overcome through the embodiments described herein by using a micron scale version of the electronic transmission described herein.

FIGS. 6A-6E illustrate a switch configuration with common busses functioning as a transmission for energy sources to achieve certain gear ratios in accordance with one embodiment of the invention. FIG. 6A illustrates a simplified schematic diagram of a switching configuration having end blocks 180a and 180b with side extensions 182a and 182b extending therebetween. In one embodiment, the end blocks and the side extensions are composed of suitable insulative material compatible with the operating conditions of the switch. Axle 184 extends through each of end blocks 180a and 180b. Lobes 186a and 186b are disposed around axle 184. Bus bars 116 and 118 extend across opposing sides of end blocks 180a and 180b. It should be noted that bus bars 116 and 118 are disposed along an upper and a lower surface of the opposing sides of end extensions 180a and 180b. Contacts 188 extend from a surface of side extensions 182a and 182b to corresponding bus bars 116 and 118. Electrically conductive bolts 190 extend through side extensions 182a and 182b. In one embodiment energy sources are directly connected to a threaded end of bolts 190. In an alternative embodiment, cables or wires can connect an end of bolts 190 and appropriate terminal of the energy sources. Contacts 192 are provided so that movement of lobe 186a or lobe 186b will force an end of the respective contact 188 against a surface of contact 192. Thus, as contact 188 is forced against a surface of contact 192, contact 188 will be moved away from contacting bus bar 118. It should be appreciated that the energy sources will be stacked to transversely extend across side surfaces of side extensions 182a and 182b in one embodiment. As will be explained in more detail below rotation of axle 184 results in displacement of contacts 188 through lobe 186.

One skilled in the art will appreciate that lobe 186 of FIG. 6A may extend across an entire surface of axle 184 in one embodiment. In this embodiment, the lobe may be configured so that rotation of axle 184 will displace certain contacts 188 depending on the degree of rotation of the axle. In another embodiment a plurality of customized lobes corresponding to each contact 188 may be included. In order to more clearly illustrate the switching configuration two lobes 186a and 186b are shown in FIG. 6A for illustrative purposes and may be utilized to support axle 184 in one embodiment. In FIG. 6A all switches are contacting bus bars 116 and 118, thus this positioning corresponds to first gear with reference to FIG. 3 and Table 1. One skilled in the art will appreciate that while there are five switches illustrated, instead of six, the bottom of the stack of energy sources is connected to the negative bus bar and the top of the stack of energy sources is connected to the positive bus bar, irrespective of the gear being provided through the switch configuration in the embodiment with the CL switch as implemented with reference to FIG. 3.

FIG. 68 is a simplified schematic diagram illustrating an alternative view of the switching configuration of FIG. 6A in accordance with one embodiment of the invention. In FIG. 6B a backside view of the switching configuration of FIG. 6A is illustrated. Side extensions 182a and 182b extend between end blocks 180a and 180b. Electrically conductive bolts 190 secure corresponding contacts 188 and provide for connections to energy sources. Bus bars 116 and 118 extend across the switching configuration from end blocks 180a and 180b. Lobe 186b is illustrated around axle 184. FIG. 6C is a simplified schematic diagram illustrating a perspective view of side extension 182 in accordance with one embodiment of the invention. Side extension 182 includes a plurality of holes extending therethrough. The holes provide access for the bolts of FIGS. 6A and 6B to secure corresponding contacts. FIG. 6D is a simplified schematic diagram illustrating a perspective view of the end block for the switching configuration in accordance with one embodiment of the invention. End block 180 includes recesses 196a and 196b on opposing side surfaces of the end block. Opening 198 extends through end blocks 180 and provides access for axle 184 of FIG. 6A. FIG. 6D is a simplified schematic diagram illustrating a perspective view of a lobe of the switching configuration in accordance with one embodiment of the invention. Lobe 186 has opening 200 extending therethrough. Opening 200 is configured to mate over axle 184 of FIG. 6A. Lobe 186 includes protrusion 202 extending from one surface so that an outer periphery of lobe 186 is not a circle having a uniform diameter. Protrusion 202 will displace one of the contacts of the switching configuration depending on the degree of rotation of the axle around which lobe 186 is disposed.

FIG. 6E is a simplified schematic diagram illustrating further details of the switching configuration of FIG. 6A in accordance with one embodiment of the invention. The switching configuration in FIG. 6C has the end blocks and side extensions transparent in order to better view further details of the switching configuration. Electrically conductive bolts 190 secure contacts 188 and 192 against corresponding surfaces of the side extensions. Axle 184 extends between and through the end extensions. Lobes 186a and 186b are disposed along axle 184. Bus bars 116 and 118 extend across opposing surfaces of the end blocks. For simplicity the bus bar attachments to the end blocks are not illustrated. It will be appreciated that the lobes 186 disposed along a length of axle 184 act as cams to lift the switches where appropriate, as per Table 1 and FIG. 3 in order to achieve the appropriate gear ratio. While the actuation of the switches is achieved through axle rotation, one skilled in the art will appreciate that the actuation may be linear in other embodiments. In addition, a disc with a conductive pattern on the disc where brushes are employed as pickup points and the disk is rotated for gears may be integrated into the embodiments described herein.

In one embodiment, for a four speed transmission, and the upper cam lobe peak positions at 45°, 90°, 135°, and 180° for the upper switches, and 225°, 270°, 315°, and 360°, respectively, for the lower switches. As noted above, the lobes or cams can be one single piece that extend along a full length of the axle, custom lobes for each switch location, or a stack of standard cams/lobes as illustrated by the lobe of FIG. 6D. In one embodiment a standard cam part is stacked on the octagonal axle with the protrusion of the lobe being rotated to the correct gear (axle) position. In one embodiment, a lockout so that the CL switch of FIG. 3 is opened prior to the axle being allowed to turn and make/break connections. It should be appreciated that while FIGS. 6A through 6E illustrate a specific switch configuration, alternative switch configurations may be integrated with the embodiments described herein. That is, solid-state, or other suitable types of connecting/interrupting devices may be utilized for the switching configuration. Exemplary materials for the axle include any suitable metal, plastic or composite material, while the lobes are composed of an insulative material, such as plastic, ceramic, or composites. The contacts are composed of a conductive material that is wear and arc tolerant, such as copper alloys in one embodiment. The bus bars are composed of a conductive material such as electroplated copper in one embodiment

In summary, the embodiments provide for an efficient electronic transmission that essentially reconfigures constrained power sources to provide the desired torque and speed. The reconfiguration of the power sources may be achieved through switches. Thus, there are no gears, pulleys, or other mechanical parts incurring inefficiencies that result in power loss from motor to wheel. Where the switches are solid state switches the transmission has no moving parts and reliability to where the doors of the vehicle will fall off first. In another embodiment, the switches may be a power vacuum tube. In the embodiments where the switches are low cost electromechanical switches, the movement of the contacts, and the camshaft that actuates them are the only moving parts of the transmission and none carry the mechanical power of the driveline. As described with regard to FIGS. 6A-E, the switching block may have a single axle that rotates cams or lobes to move contacts in order to arrange the energy sources in serial, parallel or some combination of the two. The embodiments enable further advances with regard to electric and hybrid motor vehicles in an environment friendly manner. In addition the embodiments provide for the return of excess power to the grid. As the generation of power has advanced, the storage of that power is lacking. That is, power generation has not been an issue, however, there has not been a large scale electrical means for storing the power that is generated for later use. By utilizing the stored power in the energy sources for alternative fuel vehicles the storage of generated power is achieved. Thus, each vehicle may act as a store of energy during a low cost period of time that can return excess power to the grid during peak high value periods as a method, creating an incentive for deployment of green technology vehicles that subsidizes, or perhaps even pays for, the cost of the batteries in the vehicle over its lifetime, and for subsequent battery replacement as further methods that enhance the value and economic benefits of green technology. When considering the amount of vehicles in the world, the possibilities become staggering for the leveling the generation and distribution of power, enabling the use of wind power which produces peak output when energy demand is low, and eliminating “dirty” power generating facilities that are used to satisfy peak demand.

Alternative embodiments for charging back to the grid through the electronic transmission described herein may be extended to the transmission for wind turbines where the voltage or current can be increased depending on wind speed, or turbine rotor torque/speed, that is available. In one embodiment for charging back to the grid through the electronic transmission described herein may be extended to the transmission for hydroelectric turbines where the voltage or current can be increased depending on water flow, volume, turbine torque/speed, or pressure that is available. One skilled in the art will appreciate that mechanical transmissions are the major failure mechanism for these systems. In addition, the embodiments may also be able to reduce the “cut-in speed” which is the minimum wind speed required to generate power, i.e., to actually turn the turbine. Here, the energy sources are the individual windings. In one embodiment, a generator commutator can be incorporated into the transmission (making it “brushless”) based on sensor inputs or reading EMF from the generator.

In one embodiment, electromagnetic coils, or high energy electromagnetic, microwave, or optical energy beams, may be utilized to couple energy to the vehicle, whether moving or stationary, to provide extended range or to charge the onboard energy storage device at lucrative or strategic periods of time where the transmission optimizes the available source voltage or current to the best suited voltage or current to replenish the onboard energy storage device. In another embodiment, the “charging” of the vehicle involves replenishing an energy carrier, whether a gas, a solid, a liquid, or plasma, and being a compound, element, or isotope. In one embodiment, these energy carriers are converted on the vehicle into electrical energy to become an energy source and the transmission is then used to couple this energy to the vehicle. In one embodiment, a range extending device, such as an ICE, external combustion engine, a heat (Stirling) engine, gas turbine or other motive energy device is used to drive a generator to become an energy source. In another embodiment, energy sources are converted on the vehicle into electrical energy and the transmission is then used to couple this energy to replenish onboard storage devices, to provide motive power to the vehicle, or to provide power to a grid or extra-vehicular device.

In yet another embodiment, the energy sources are solar cells which can have variable current output due to varying irradiance conditions, whereby the solar cells' power output is coupled to the transmission to provide a maximum threshold current, or voltage, to a motor, to a grid or to any other device that requires significant current traded for voltage. In one embodiment, a solar powered vehicle operates at its maximum power point (MPP), where the product of output current and output voltage is maximized for a given load resistance, thereby limiting the available current. This system utilizes the transmission to maintain acceleration performance to overcome inertia and static friction in conditions of low irradiance at the expense of top speed, and once moving, the current for the same irradiance can be reduced with the transmission reconfiguring the system to improve speed at the expense of acceleration performance since rolling and wind resistance may require less motor torque than acceleration; all while operating the photovoltaic energy sources at, or near, their MPP. In another embodiment, the energy sources are not housed in a vehicle and the transmission is used to optimize the range of voltage or current, torque or speed, or any other product of entities that equates to power or energy or allows the energy source or energy consuming device to operate at its inherent, or most efficient, voltage, current, or operating point at varying conditions.

While this invention has been described in terms of several embodiments, it will be appreciated that those skilled in the art upon reading the preceding specifications and studying the drawings will realize various alterations, additions, permutations and equivalents thereof. Therefore, it is intended that the present invention includes all such alterations, additions, permutations, and equivalents as fall within the true spirit and scope of the invention.

What is claimed is:

1. An apparatus, comprising:
a plurality of reconfigurably interconnected energy sources;
a controller that receives energy from the plurality of energy sources and regulates output energy; and
a device for converting the output energy of the controller into one of a force or a rate.

2. The apparatus of claim 1, wherein the plurality of energy sources are one of batteries, fuel cells, wind turbines, solar cells, electrical generators, energy generators or power generators.

3. The apparatus of claim 1, wherein the controller is an inverter that converts a direct current to an alternating current.

4. The apparatus of claim 1, wherein the device is an electric motor.

5. The apparatus of claim 1, further comprising:
a plurality of switches coupled to corresponding energy sources, a first conductive trace and a second conductive trace, the first and second conductive traces in electrical communication with respective input terminals of the controller.

6. The apparatus of claim 5 further comprising:
a switch coupling the first conductive trace to the controller, and wherein the second conductive trace is hardwired to the respective input terminal of the controller.

7. The apparatus of claim 5, wherein the plurality of switches are configurable to arrange the energy sources in one of a serial or parallel arrangement.

8. An apparatus, comprising:
a plurality of reconfigurably interconnected energy sources; and
a device for converting output energy of the plurality of reconfigurably interconnected energy sources into one of a force or a rate.

9. The apparatus of claim 8, further comprising:
a switching block coupled to the energy sources, the switching block having a rotatable axle, the rotatable axle causing the energy source to be connected in one of a serial, a parallel or a combination of serial and parallel configuration.

10. A transmission for a device, comprising;
a plurality of switches reconfigurably coupled to corresponding energy sources and a common energy conduit.

11. The transmission of claim 10, wherein a position of the plurality of switches dictates a maximum amount of current and a maximum amount of voltage provided to an electric motor through the common energy conduit, thereby regulating a maximum torque and maximum speed of the motor.

12. The transmission of claim 11, wherein the transmission is located outside of a drive train defined between an output of the motor and wheels being driven by the motor and wherein the common energy conduit is a conductive trace.

13. The transmission of claim 11, wherein the transmission is located one of within or upon the energy sources.

14. The transmission of claim 11, wherein the transmission is located one of within or upon a power output device coupled to the electric motor.

15. The transmission of claim 10, wherein the plurality of switches are positioned through rotation of a single axle.

16. The transmission of claim 10, wherein the transmission is housed in a motor vehicle outside a drive line defined between an output of a motor powering the vehicle and a wheel of the vehicle.

17. The transmission of claim 10, wherein the energy sources provide power to a power grid

18. The transmission of claim 15, wherein the energy sources are one of batteries, fuel cells, wind turbines, solar cells, electrical generators, energy generators, power generators, energy storage devices or power storage devices.

19. A transmission for a motor vehicle consisting of:
a plurality of immobile components.

20. The transmission of claim 19, wherein each of the plurality of immobile components is a solid state switch.

21. The transmission of claim 19 wherein the plurality of immobile components switch a plurality of energy sources between one of a series and a parallel configuration.

22. A vehicle, comprising;
a torque conversion module located outside of a drive line of the motor vehicle, the drive line defined between an output of a motor powering the vehicle and a wheel of the vehicle.

23. The vehicle of claim 22, wherein the torque conversion module modifies an arrangement of energy sources supplying energy to the motor between one of a series, a parallel and a series parallel combination.

24. A transmission for a motor vehicle, comprising:
a first conductive trace providing a first selectable electrical pathway from each of a plurality of immobile energy sources; and
a second conductive trace providing a second selectable electrical pathway from each of the plurality of immobile energy sources.

25. The transmission of claim 24, wherein the first and second conductive traces are provided to corresponding first and second input terminals of a pulse width modulation controller.

26. The transmission of claim 24, further comprising;
a first plurality of switches selectably coupling the plurality of immobile energy sources; and
a second plurality of switches selectably coupling the plurality of immobile energy sources to one of the first or the second trace.

27. The transmission of claim 26, wherein each of the switches is a solid state switch.

28. The transmission of claim 24, wherein the first conductive trace and the second conductive trace are disposed on opposing surfaces of an end block.

29. The transmission of claim 24, wherein the first conductive trace and the second conductive trace extend across opposing surfaces of both a first and a second end block, the first and second end block having an upper and lower side extension coupling the first and the second end blocks.

30. The transmission of claim 29, wherein a plurality of contacts transversely extend across corresponding planar surfaces of the upper and lower side extensions.

31. The transmission of claim 30, wherein an axle extends through the first and second end blocks and wherein rotation of the axle defines a coupling configuration of the plurality of immobile energy sources.

32. A method for converting one of torque or speed, comprising;
selectably arranging a plurality of energy sources to provide differing voltage levels based on desired speed; and
selectably arranging the plurality of energy sources to provide differing current levels based on desired torque.

33. The method of claim 32, wherein the selectably arranging is performed through opening and closing electrical pathways between the energy sources and a motor coupled to the energy sources.

34. The method of claim 33 wherein the opening and closing is performed through solid state switches.

34. The method of claim 32, wherein the selectably arranging comprises:
configuring the plurality of energy sources in one of a parallel, a series, a parallel/series combination, the configuring performed while the energy sources are electrically disconnected from one of a motor or other electrical devices of a motor vehicle.

35. The method of claim 32, wherein the plurality of energy sources are one of batteries, fuel cells, electrical generators or solar cells for a motor vehicle.

36. A method of supplying power to a power grid, comprising;
discharging energy into the power grid from a motor vehicle.

37. The method of claim 37, further comprising:
calculating one of an amount of energy required for a trip or an amount of time to a next charge;
calculating an amount of energy in excess of the amount of energy required for one of the trip to or the time for the next charge; and
supplying, at most, an amount of energy in excess of the amount of energy required for one of the trip or the time to the next charge to the power grid.

38. A method for converting one of voltage or current, comprising;
selectably arranging a plurality of energy sources to provide differing voltage or current levels based on one of generator speed, generator torque, solar cell irradiance, fuel cell maximum current, battery maximum current, battery temperature, battery life cycle limitations, or battery operating points.

39. The method of claim 38, wherein the selectably arranging includes configuring the plurality of energy sources in one of a parallel, a series, a parallel/series combination
